(19) United States
(12) Patent Application Publication
(10) Pub. No.: US 2004/0268211 A1
(43) Pub. Date: Dec. 30, 2004

(54) Systems and methods for analyzing and reporting electronic content

(76) Inventor: Christopher James Huff, Franklin, IN (US)

Correspondence Address: x3Church (Craig Gross), 3256 Mountain Pass Drive, Corona, CA, 92882, US

(21) Appl. No.: 10/460,719

(22) Filed: Jun. 13, 2003

(51) Int. Cl. G06F 17/00

(52) U.S. Cl. 715/500

(57) ABSTRACT

Systems and methods for analyzing and reporting electronic content for Internet user accountability are described. The systems and methods in the present invention consist of a content-based software solution, for use on a personal computer, to determine inappropriate content and record content location. Log files of content are automatically sent electronically to those whom the user is accountable. Reporting of the log file is done on a scheduled basis.

The software invention consists of two programs; the main program for analyzing and reporting electronic content and the sub-program for detection of deletion to the main program. Due to length of code, the programs are included via the CD-R (Copy 1 or Copy 2) as mainprogram.txt (74038 bytes, dated May, 19, 2003) and subprogram.txt (24576 bytes, dated May 19, 2003).

### BACKGROUND OF THE INVENTION

The Internet has opened up many new methods of data exchange including electronic mail (e-mail), Internet applications, and the most common, the web page. Web pages are like the pages of a book. In the case of the Internet, these collections are called web sites. A web site is a collection of web pages about a common product, item, hobby, or other subject.

The wealth of available information on web sites is vast and uncontrollable. An example is the easy anonymous viewing of pornography. A result of online pornography is the growth in filtering-software companies like Cyber Patrol, developed by Surf Control, Inc., of Scotts Valley, Calif. and I-Gear, developed by Symantec Corporation, of Cupertino, Calif. These companies have developed methods of identifying pornographic or “inappropriate” web sites and preventing the software users from accessing such sites. These methods range from list-based, where sites are validated against a list of known pornographic sites, to context-based where the text within a site is checked and validated against the context of the text to determine if the site is inappropriate.

There is software similar to filtering called accountability software. This software works like those mentioned above but does not prevent a user from viewing the sites. Instead, all inappropriate electronic content is recorded and is sent, via a regular report, to the user's accountability partner(s). It is the job of the accountability partner to confront the user if they view inappropriate sites. People without children commonly use this software where exposing children to inappropriate material is not a concern. The core users of this type of software are those trying to free themselves from pornography addictions and those who want to actively avoid such sites.

Current accountability software, such as Covenant Eyes of Corunna, Mich., requires dedicated remote servers to do all web site content analysis, storage, and reporting. The disadvantage is the cost server maintenance, which easily totals in the four to five figures for an average year. Therefore, companies using this type of software must require a monthly subscription fee.

The current software also requires private user information to be shared, such as name, address, and e-mail address. While most of this information is kept securely by the software creators, people with addictions do not like to make their names public. The results of a name or address disclosure can produce chattered reputations, job loss, and divorce.

In view of these issues, it would be desirable to provide systems and methods for analyzing and reporting electronic content of Internet user accountability, which does not require personal information and can be run at a minimal maintenance cost.

It would also be desirable to develop systems and methods that could be run securely within the user's computer without allowing the user to make unwarranted modifications to their report files and notify the accountability partner(s) if such an event occurred.

It would also be desirable to develop systems and methods that would run within the user's computer and keep all report files private from other users of the same computer.

It would also be desirable to develop systems and methods that would detect any user modifications to the expected behavior that would normally be controlled on a remote server.

Finally, it would be desirable to develop systems and methods that could detect software deletion and/or re-installation on the user's personal computer, as an attempt to erase the log file, and notify the accountability partner(s) if such an event occurred.

### SUMMARY OF THE INVENTION

In view of the following, it is an object of the invention to provide systems and methods for analyzing and reporting electronic content for Internet user accountability.

It is another object of the invention to provide systems and methods for determining inappropriate content on the basis of weighted word combinations such as “sex,” “children,” and “ass” found within the electronic content.

A further object of the invention is the allowance for sites to be viewed even if deemed inappropriate. Users are given the freedom to view any existing site without issues of the application preventing viewing of appropriate sites which might be improperly detected. Such a site could include a health site on pregnancy.

An object of the invention is the elimination of need for user information, which includes name, e-mail address, residence-related information such as address or phone number, or any other information unique to readily identifying the user.

Another object of the invention is the elimination of remote Internet servers for the storage and analysis of content. All analysis and storage occurs on the user's personal computer.

An object of the invention is the use of a generic e-mail address for sending all reports. The user's e-mail address and identity would not be revealed given a possible interception of the e-mail report.

An object of the invention is the protection of the recorded data from the user. All data related to the specific user is encrypted and hidden on the user's personal computer. Deletion of any of these key files triggers the application to force a “new user setup” window to appear at system start-up and the accountability partner is notified of the discretion. Any attempt to edit encrypted files causes the system to require either a re-installation or “new user setup” window to appear and the accountability partner is notified.

Another object of the invention is the protection of privacy within the user's personal computer. All report and accountability partner information, which includes the e-mail address of the recipient of the reports, is encrypted via a method using an encryption key. Therefore, if someone other than the user accessed the record files, that person could not determine the users record sites or the accountability partner's email address.

A further object of the invention is to record any user-attempted intervention of the application. If the user closes the application from running, an entry is added to the log file indicating the date and time with a note the user manually closed the application. If a user attempts to use a third-party firewall application such as ZoneAlarm or BlackIce to stop the transmission of the report to the accountability partner, an entry is added to the log file indicating the date and time with a note the report was not successfully sent. The application then continues to re-send the report upon every subsequent computer start up, or date change, until the report is successfully send.

Another object of the invention, related to the above, is the detection of the presence of the software. Deletion or re-installation of the software will generate a message for the accountability partner that the user tried to delete the record log.

This invention, being described within this document, has an existing user count of over ten thousand people within the first six months of availability primarily because of the differences in the software from the current market.

The systems and methods of the invention involve a software solution consisting of four main components: (1) a configuration interface; (2) an electronic content analyzer; (3) a reporting process; and (4) a small amount of web site hosting space.

The configuration interface consists of a user-accessible window, which enables the user to add/delete multiple accountability partner e-mail addresses. The user can also vary the reporting period between 2-weeks and 4-weeks. The user must also add/edit a username. The username is required in order for accountability partners to identity reports from multiple users.

The electronic content analyzer reads the content of each visited electronic document, such as an Internet web site, and determines if the site is inappropriate based on a weighted-keyword algorithm. Those deemed inappropriate are passed to a process of encryption and recording. Before being encrypted, sites are reviewed against a list of safe sites. If the site matches, the site is not logged.

The reporting process, occurring at regular intervals, decrypts the data and builds a temporary file, which contains the data and the e-mail addresses of the accountability partners. The file is uploaded to a web site and executed via the application. This file execution causes the report to be e-mailed using a generic e-mail address such as report@softwaresite.org. The application then deletes the temporary file from the web site and clears out the user log for the next reporting period.

The web hosting space is required for sending e-mail from a generic address. This is done by automatically transferring a specially prepared file to the web site and executing it via the user application. After sending, the file is promptly deleted from the user's personal computer.

The invention enables users, concerned with the temptation of visiting inappropriate Internet sites, to be accountable for their actions by recording and reporting visited electronic documents of inappropriate content.

Although the description above contains many specifications, these should not be construed as limiting the scope of the invention but as merely providing illustrations of some of the presently preferred embodiments of this invention. For example, a business could use this program to monitor employee Internet browsing by pointing the accountability partner email to a business address and removing the option to change accountability partner email addresses; the key words used to identify pornography sites could be substituted with different words to benefit someone with an Internet gambling problem.

Thus the scope of the invention should be determined by the appended claims and their legal equivalents, rather than by the examples given.

### BRIEF DESCRIPTION OF THE DRAWINGS

FIG. 1 is a schematic view of the system and network environment in which the invention operates.

FIG. 2 is an illustrative view of the systems and methods of the invention for analyzing and recording electronic documents on a personal computer.

FIG. 3 is a schematic view of the software components of the invention.

FIG. 4 is an illustrative view of the weighing system used to determine inappropriate content.

FIG. 5 is an illustrative view of the configuration form.

FIG. 6 is a flowchart for usage of the software components to analyze electronic content.

FIG. 7 is a flowchart for usage of the software components of the reporting process.

FIG. 8 is a schematic view of the web site hosting space usage

FIG. 9 is a schematic view of the sub-process for software detection.

### DETAILED DESCRIPTION OF THE INVENTION

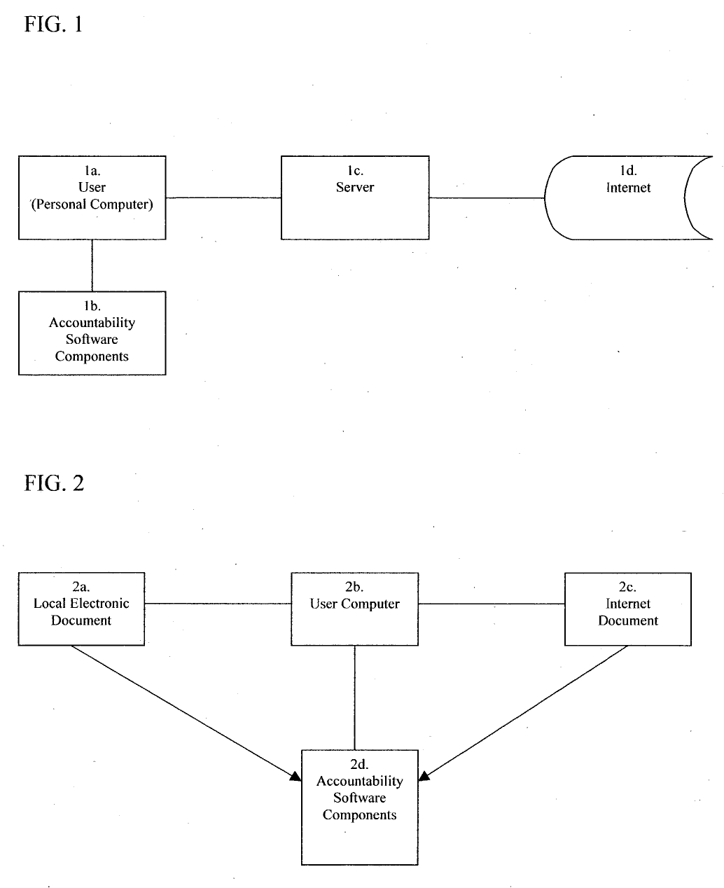

Referring to FIG. 1, a schematic view of the system and network environment in which the invention operates is described. Users 1a are connected to the Internet 1d by means of a server 1c. User 1a connects to the Internet 1d using a personal computer. Server 1c may be a local proxy server on a local area network, a remote proxy server, or a web server of an Internet service provider. An example of local area network access is an educational institution or large networked business complex.

Users 1a connect to the Internet 1d to access electronic content in the form of web pages. Analysis and recording of electronic content viewed by users 1a is controlled by the software invention installed on the user's personal computer. The software invention consists of the software components 1b that are installed by the user 1a on the user's personal computer.

The software components 1b determine whether electronic content viewed by the user 1a is inappropriate. If the electronic content from the Internet 1d is deemed inappropriate by the software components 1b then the location of the content is recorded by the software components 1b.

Referring to FIG. 2, an illustrative view of using the systems and methods of the present invention to analyze electronic content is described. A personal computer 2b enables a user to access electronic documents (2a & 2b), specifically web pages, stored on either the Internet or on the user's personal computer.

A personal computer has software components 2d to monitor the content of both local 2a and Internet-based 2c electronic documents. Every time a user 2b requests an electronic document, the software components 2d check the content of the document to determine if it's inappropriate. The user is responsible for installing and configuring the software for usage on the personal computer.

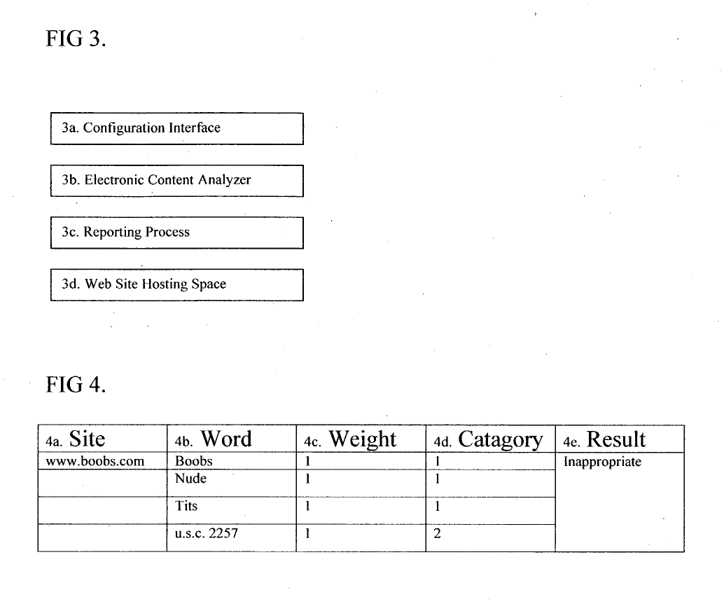

Referring to FIG. 3, a schematic view of the software components is described. The components consist of: (1) a configuration interface 3a; (2) an electronic content analyzer 3b; (3) a reporting process 3c; and (4) web site hosting space 3d.

The configuration interface 3a consists of a configuration window that enables the user to specify one or two accountability e-mail addresses, the reporting period, and a pseudo-name for identification within the report as to the sender. The configuration interface 3a is presented upon installation and is available for configuration changes at any time via an options window available when the personal computer is functioning, regardless of any Internet connection.

The electronic content analyzer 3b is included in the software installation on the personal computer, to monitor electronic content. The electronic content may be displayed as a web page or other similar document stored in electronic form such as an XML file. The electronic content analyzer 3b scans all browser windows common to the Internet community including Microsoft Internet Explorer, Netscape, Opera, Mozilla, and the integrated America Online (AOL) browser.

The content analyzer 3b implements the functions required to perform a word-based analysis of the electronic document to determine if the content is appropriate. The electronic documents are commonly web pages. The analyzer also checks against a list of safe sites. Safe sites are known sites that are appropriate but are determined by the software to be inappropriate.

Referring to FIG. 4, an illustrative view of the weighing system used to determine inappropriate content is described. The electronic document, specifically the web site 4a, is parsed to find expected keywords. The found key words 4b, are then weighed 4c and given a category rating 4d. A category rating such as “2” determines the site is definitely dealing with pornography based only on one word. In the word column 4b, the key word “u.s.c. 2257” is listed as a category “2” because most pornographic sites display a disclaimer required by US law in which section “u.s.c. 2257” of the law is referred. Any word found in category “2” marks the site as inappropriate. In the case of category “1” words, three or more of these words must be found for the site to be deemed inappropriate. An electronic document on ‘nude paintings of the 19^{th} century’ would not be counted as inappropriate. FIG. 4 shows a site in which three category “1” words and one category “2” word is found.

The reporting process 3c runs on a scheduled basis, compiles a list of electronic documents viewed by the user and deemed inappropriate, and sends the report to the accountability partner(s). This process 3c, once successfully completed, then re-sets the user log for continued usage.

Web site hosting space 3d is required for the sending of accountability reports in order to maintain user privacy. The accountability report is sent to the web space, via a file upload process, and is sent to the accountability partner(s) via a generic e-mail address such as report@softwaresite.org.

I. Configuration Interface

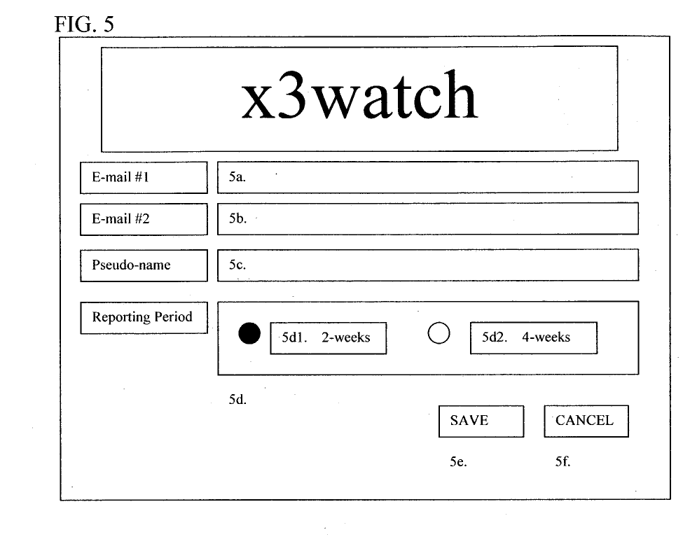

Referring to FIG. 5, an illustrative view of the configuration interface is described. The interface allows for one or two accountability e-mail addresses 5a & 5b. These are the addresses of those who the user is accountable for their electronic content viewing habits. At least one e-mail address 5a is required to save 5e the configuration settings. If an e-mail address is deleted then the e-mail address of the person deleted is sent a notification that the user has removed them as an accountability partner. If an email address 5a & 5b is added, then the e-mail address holder is sent an e-mail notification stating they have been added as the accountability partner of the user.

The interface also allows for reporting period modifications 5d. Presently, the reporting periods are defined as 14 days and 28 days though the invention does contain the ability to be modified for different periods. When a user alters a reporting period, after installation configuration, the time until the next report generation is adjusted based on the last time in which a report had been generated. After such time, the report is generated at the requested interval. Any change in the reporting period 5d sends an e-mail notification to the accountability partner(s). A default period 5d1 is set upon installation and the reporting period is required to save 5e the configuration changes.

Finally, the interface allows for entry of a required pseudo-name 5c. The user, for identification in their accountability report, chooses the pseudo-name. This name can be any identifier that the accountability partner can use to distinguish reports from more than one user. A change in the pseudo-name 5c sends an e-mail notification to the accountability partner(s). A pseudo-name is required to save 5e the configuration changes.

The ability to cancel a configuration change is provided with a cancel option 5f. The cancel button 5f will re-set the configuration options to the last saved state.

II. Content Analyzer

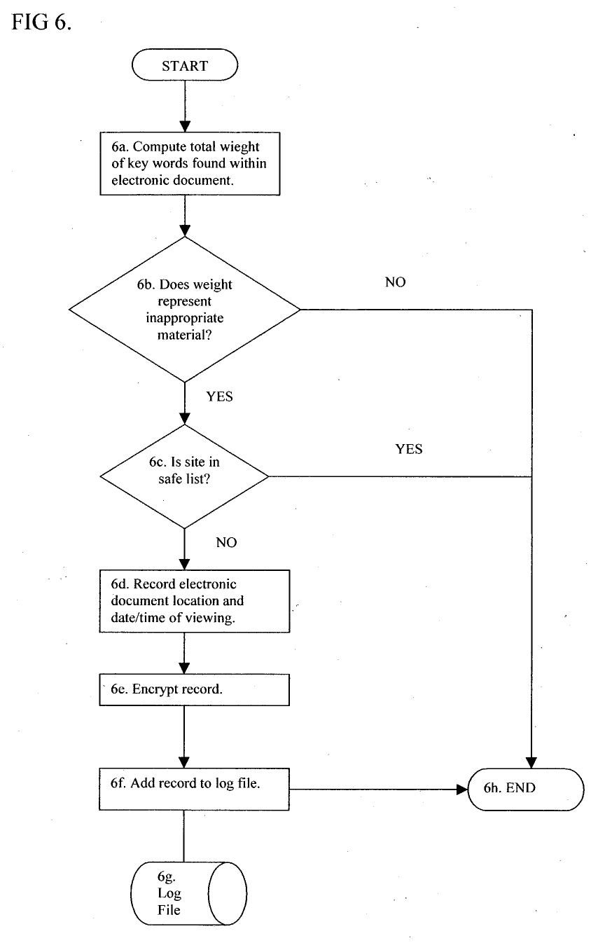

Referring to FIG. 6, a flowchart for usage of the software components to analyze electronic content is described. The electronic document may be a web site or similar electronic content. The software component checks the electronic document, at step 6a, to find key words typically found on a pornographic site. If the analyzer determines the document does contain any such words, an algorithm is used to give each word a weight. The weights are totaled and the analyzer determines if the electronic document is likely pornographic in nature.

If the analyzer determines the electronic document to be pornographic 6b, and the document is not listed as a safe site 6c, then the analyzer adds a new record 6d to the user log file. This line contains the document location, such as “http://www.boobs.com/index.html” along with the day and time the user viewed the document. Before the line is added to the log file 6f, it is encrypted 6e using a lock-and-key based encryption method in which a string of characters are used within the encryption method and the same string must be used in the decryption method. This encryption prevents a user from altering their log as well as protects their private information from other individuals.

The content analyzer constantly scans the user's computer to find new electronic documents that the user is viewing.

III. Reporting Process.

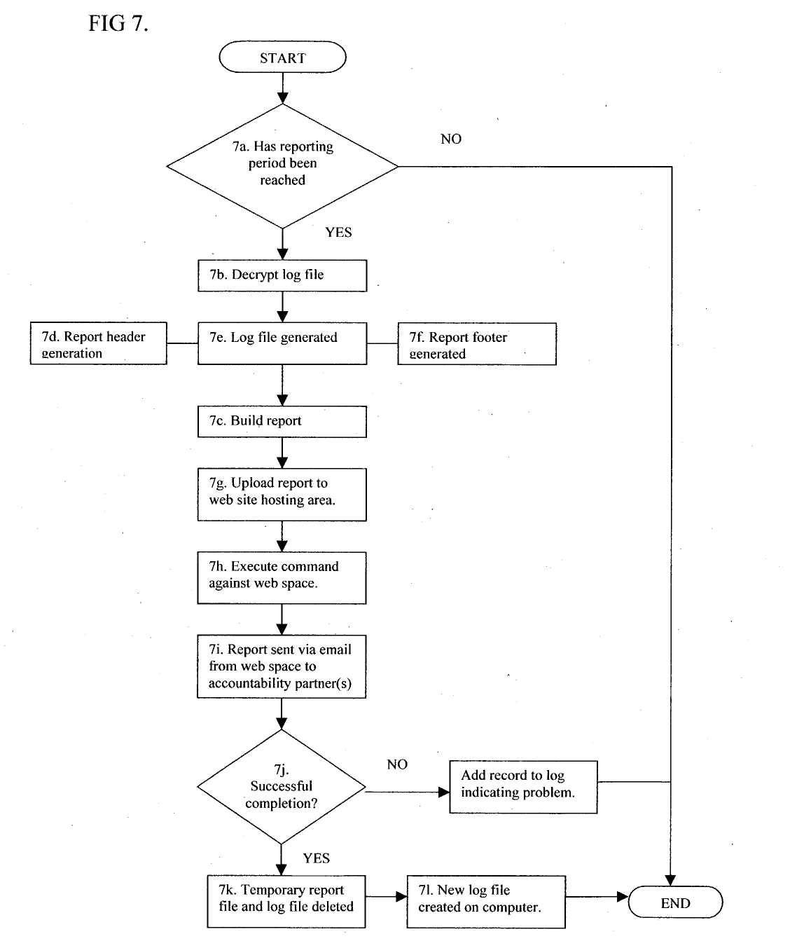

Referring to FIG. 7, a flowchart for usage of the software components of the reporting process is described. The software components regularly scan the computer date and compare it to the date of the last generated report. In the case of initial set-up, it compares it to the date of installation. If the date span 7a is greater than the reporting period, then a report is generated and is e-mailed to the accountability partner(s).

The reporting process begins by decrypting 7b the user's log file. This decryption process uses a decryption key, a string of characters, and de-scrambled the user log into readable information. Then report is then built 7c from three pieces. The report contains a header 7d for the recipient that identifies the purpose of the e-mail and indicates the pseudo-name of the user. The report then lists the log contents 7e from the user, as date of viewing followed by electronic document location. The report footer 7f contains general software information. The report header and footer can be modified to display other information.

Once the report has been created and stored in a temporary area, the software components upload 7g the report to a web site hosting area. The program then executes a command against that web space 7h and sends the report 7i from a generic e-mail address. If either of these steps are not completed successfully, then a new entry is added 7j to the log file indicating a problem with the report generation. It is possible the user could have a software product like ZoneAlarm that enables them to monitor all hidden Internet and file-related activity on their computer and thus stop the transmission or execution of the report.

When the report is successfully sent 7k, the temporary report file is deleted and the log file is erased. A new log file is created 7l and it stores the date of the report generation for later comparison by the content analyzer for the determination of report processing.

IV. Web Site Hosting Space.

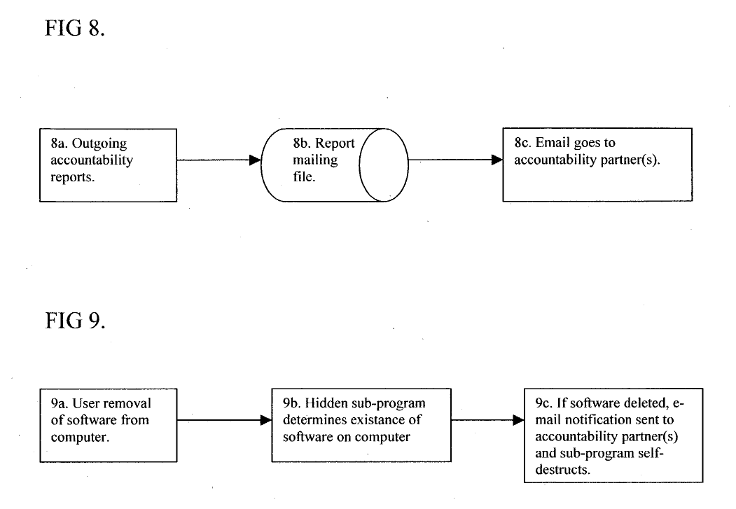

Referring to FIG. 8, a schematic view of the web site hosting space usage is described. The web site hosting space holds temporary outgoing accountability reports 8a. The software components call a file 8b on the web site hosting space that causes the report to be e-mailed to the accountability partner(s) 8c. Given the requirements and limitations of e-mail sending, via the Internet, combined with the need for user privacy, this method sends the e-mail from a generic e-mail address and thus protects privacy in case of e-mail interception. It also meets the requirements of electronic mail transfers across Internet mail servers.

At any point in the above four main processes, the software components use a combination of field requirements, encryption, decryption, content analysis, and report transmission detection to thwart privacy violation and user modifications. Attempts at these produce a notification to the accountability partner(s). Examples of detection include notifying the user if the log file has been deleted from the system or if dates on two separate configuration files are in synch.

Referring to FIG. 9, a schematic view of the sub-process for software detection is described. The software components contain a single use sub-program for the detection of the application on the personal computer once the software components have been installed. Upon user removal 9a of the application, the hidden sub-program sends 9b an e-mail to the accountability partner(s) notifying them the user has removed the application. After this e-mail is sent, the sub-program self-destructs 9c.

The above description is only for the purpose of illustration. Detailed features shown in one drawing may not be shown in another, only as a matter of convenience and brevity when necessary. The steps listed above may be combined or reordered or added with additional steps. Further variations will be apparent and are intended to fall within the scope of the claims.

What is claimed is:

1. A method for analyzing and reporting electronic content, the method comprising: determination of inappropriate content. The method includes parsing the electronic document to find key words. The key words are weighted and, based on the weight total of the key words for a given document, the document is either deemed appropriate or inappropriate.

2. The method of claim 1, wherein the weight of a word is based on the likelihood the word is related to pornography.

3. The method of claim 1, wherein the total weight, combined with the number of instances of key words, determines the appropriateness of the electronic document.

4. The method of claim 1, wherein the electronic document is viewable by the user, regardless of appropriateness.

5. A method for analyzing and reporting electronic content, the method comprising: recording the location of the electronic document if the document is a web page and the page is found to be inappropriate.

6. A method of claim 5, wherein the inappropriate electronic documents are recorded into a log file and each log record contains the electronic document location, the date and time in which the user viewed the document, and each log record is encrypted.

7. A method for analyzing and reporting electronic content, the method comprising: protecting the user's privacy by not requiring identifiable personal information to be recorded.

8. A method of claim 7, wherein the user generates a pseudo-name for identification.

9. A method of claim 7, wherein a pseudo-name is used to enable the accountability partner(s) to differentiate the users when receiving reports from multiple users.

10. A method of claim 7, wherein a generic e-mail address is used for the transmission of electronic reports.

11. A method for analyzing and reporting electronic content, the method comprising: limiting the analyzing and recording process to the user computer without need for a remote server.

12. A method for analyzing and reporting electronic content, the method comprising: a method of user privacy via encryption for the log file and all other data files stored on the user's personal computer.

13. A method of claim 12, wherein an encryption formula is used to secure data and make it unintelligible when viewed by a user or anyone with access to the user's personal computer.

14. A method of claim 12, wherein encrypted data files are hidden on the user computer to further secure the data.

15. A method of claim 12, wherein users are not able to understand the encrypted file and therefore can't edit the log file.

16. A method for analyzing and reporting electronic content, the method comprising: recording user-attempted intervention of the application into a log file that is reported to the accountability partner.

17. A method of claim 16, wherein user-intervention includes tampering with the log file, configuration file, or secondary configuration file.

18. A method of claim 16, wherein user-intervention includes using third-party firewall devices to stop the transmission of the electronic report.

19. A method for analyzing and reporting electronic content, the method comprising: recording the re-installing of the invention or the deletion of the invention from the user computer.

20. A method of claim 19, wherein during the normal computer start-up process, it is determined if the invention is still resident on the user computer.

21. A method of claim 19, wherein the absence of the invention, after original invention installation, generates a one-time e-mail to the accountability partner stating the user has deleted the invention from their computer.

22. A method of claim 19, wherein the accountability partner is automatically notified if the invention has been installed or re-installed on the user computer.

23. A method for analyzing and reporting electronic content, the method comprising; recording configuration changes via a user form to alter accountability partner e-mail addresses, reporting frequency, and pseudo-name.

24. A method of claim 23, wherein the user installs the invention and immediately completes a configuration form.

25. A method of claim 23, wherein at least one accountability partner e-mail address is required.

26. A method of claim 23, wherein a pseudo-name is required.

27. A method of claim 23, wherein a reporting period is required though defaults to most frequent allowable reporting period.

28. A system for analyzing and reporting electronic content, the system comprising: a configuration interface; an electronic content analyzer; a reporting process; and web site hosting space.

29. A system of claim 28, wherein a configuration interface allows entry of accountability partner e-mail addresses, user pseudo-name, and the reporting period in days.

30. A system of claim 28, wherein an electronic content analyzer is used to determine the appropriateness of an electronic document.

31. A system of claim 28, wherein a reporting process of decrypting log files and sending via electronic mail is used for providing Internet accountability.

32. A system of claim 28, wherein web hosting space is used for the sending of electronic reports to retain user privacy by using a generic e-mail sender address.
